(19) United States
(12) Patent Application Publication
(10) Pub. No.: US 2008/0231027 A1
(43) Pub. Date: Sep. 25, 2008

(54) Method and apparatus for classifying a vehicle occupant according to stationary edges

(75) Inventors: Yun Luo, Livonia, MI (US); Raymond J. David, Dearborn Heights, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/726,460

(22) Filed: Mar. 21, 2007

(51) Int. Cl. B60R 21/26; B60R 21/01; G01V 8/10

(52) U.S. Cl. 280/735; 382/209; 382/254; 382/260; 701/45

(57) ABSTRACT

System and methods are provided for classifying an occupant of a vehicle. An edge image generation component (102) produces an edge image of a vehicle occupant. A long term filtering component (104) filters across a plurality of edge images to produce a static edge image. A feature extraction component (106) extracts a plurality of features from the static edge image. A classification component (108) selects an occupant class for the vehicle occupant according to the extracted plurality of features.

### TECHNICAL FIELD

The present invention is directed generally to pattern recognition classifiers and is particularly directed to a method and apparatus for classifying a vehicle occupant according to stationary edges. The present invention is particularly useful in occupant restraint systems for object and/or occupant classification.

### BACKGROUND OF THE INVENTION

Actuatable occupant restraining systems having an inflatable air bag in vehicles are known in the art. Such systems that are controlled in response to whether the seat is occupied, an object on the seat is animate or inanimate, a rearward facing child seat present on the seat, and/or in response to the occupant's position, weight, size, etc., are referred to as smart restraining systems. One example of a smart actuatable restraining system is disclosed in U.S. Pat. No. 5,330,226.

Pattern recognition systems can be loosely defined as systems capable of distinguishing between classes of real world stimuli according to a plurality of distinguishing characteristics, or features, associated with the classes. A number of pattern recognition systems are known in the art, including various neural network classifiers, self-organizing maps, and Bayesian classification models. A common type of pattern recognition system is the support vector machine, described in modern form by Vladimir Vapnik [C. Cortes and V. Vapnik, “Support Vector Networks,” Machine Learning, Vol. 20, pp. 273-97, 1995].

Support vector machines are intelligent systems that generate appropriate separating functions for a plurality of output classes from a set of training data. The separating functions divide an N-dimensional feature space into portions associated with the respective output classes, where each dimension is defined by a feature used for classification. Once the separators have been established, future input to the system can be classified according to its location in feature space (e.g., its value for N features) relative to the separators. In its simplest form, a support vector machine distinguishes between two output classes, a “positive” class and a “negative” class, with the feature space segmented by the separators into regions representing the two alternatives.

### SUMMARY OF THE INVENTION

In accordance with one exemplary embodiment of the present invention, a method is provided for classifying a vehicle occupant into one of a plurality of occupant classes. A series of edge images of the vehicle occupant is produced. A static edge image is produced by filtering across the series of edge images. A plurality of features are extracted from the static edge image. An occupant class is selected for the vehicle occupant according to the extracted plurality of features.

In accordance with another exemplary embodiment of the present invention, a classification system is provided for a vehicle occupant protection device. An edge image generation component produces an edge image of a vehicle occupant. A buffer stores a plurality of edge images produced by the edge image generation component. A long term filtering component filters across the plurality of edge images stored in the buffer to produce a static edge image. A feature extraction component extracts a plurality of features from the static edge image. A classification component selects an occupant class for the vehicle occupant according to the extracted plurality of features.

In accordance with yet another exemplary embodiment of the present invention, a computer readable medium is provided comprising a plurality of executable instructions that can be executed by a data processing system. An edge image generation component produces a series of edge images of a vehicle occupant. A long term filtering component filters across the series of edge images to produce a static edge image. A feature extraction component extracts a plurality of features from the static edge image. A classification component selects an occupant class for the vehicle occupant according to the extracted plurality of features. A controller interface provides the selected occupant class to a vehicle occupant protection device.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic illustration of an actuatable restraining system in accordance with an exemplary embodiment of the present invention;

FIG. 2 illustrates a vehicle occupant classification system utilizing long term filtering in accordance with an aspect of the present invention;

FIG. 3 illustrates an exemplary vehicle occupant classification system utilizing long term filtering in accordance with an aspect of the present invention;

FIG. 4 illustrates an exemplary classification methodology in accordance with an aspect of the present invention; and

FIG. 5 illustrates a computer system that can be employed to implement systems and methods described herein, such as based on computer executable instructions running on the computer system.

### DESCRIPTION OF PREFERRED EMBODIMENT

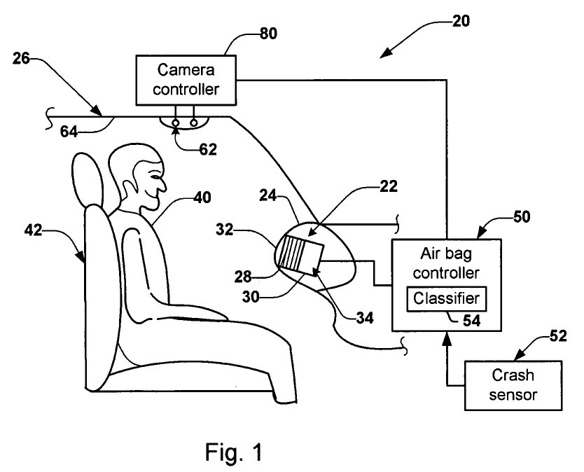

Referring to FIG. 1, an actuatable occupant restraint system 20, in accordance with an exemplary embodiment of the present invention, includes an air bag assembly 22 mounted in an opening of a dashboard or instrument panel 24 of a vehicle 26. The air bag assembly 22 includes an air bag 28 folded and stored within the interior of an air bag housing 30. A cover 32 covers the stored air bag and is adapted to open easily upon inflation of the air bag 28.

The air bag assembly 22 further includes a gas control portion 34 that is operatively coupled to the air bag 28. The gas control portion 34 may include a plurality of gas sources (not shown) and vent valves (not shown) for, when individually controlled, controlling the air bag inflation, (e.g., timing, gas flow, bag profile as a function of time, gas pressure, etc.). Once inflated, the air bag 28 may help protect an occupant 40, such as a vehicle passenger, sitting on a vehicle seat 42. Although the embodiment of FIG. 1 is described with regard to a vehicle passenger seat, it is applicable to a vehicle driver seat and back seats and their associated actuatable restraining systems. The present invention is also applicable to the control of side actuatable restraining devices and to actuatable devices deployable in response to rollover events.

An air bag controller 50 is operatively connected to the air bag assembly 22 to control the gas control portion 34 and, in turn, inflation of the air bag 28. The air bag controller 50 can take any of several forms such as a microcomputer, discrete circuitry, an application-specific-integrated-circuit (“ASIC”), etc. The controller 50 is further connected to a vehicle crash sensor 52, such as one or more vehicle crash accelerometers. The controller monitors the output signal(s) from the crash sensor 52 and, in accordance with an air bag control algorithm using a deployment control algorithm, determines if a deployment event is occurring (i.e., an event for which it may be desirable to deploy the air bag 28). There are several known deployment control algorithms responsive to deployment event signal(s) that may be used as part of the present invention. Once the controller 50 determines that a deployment event is occurring using a selected crash analysis algorithm, for example, and if certain other occupant characteristic conditions are satisfied, the controller 50 controls inflation of the air bag 28 using the gas control portion 34, (e.g., timing, gas flow rate, gas pressure, bag profile as a function of time, etc.).

The air bag restraining system 20, in accordance with the present invention, further includes a camera 62, preferably mounted to the headliner 64 of the vehicle 26, connected to a camera controller 80. The camera controller 80 can take any of several forms such as a microcomputer, discrete circuitry, ASIC, etc. The camera controller 80 is connected to the air bag controller 50 and provides a signal to the air bag controller 50 to provide data relating to various image characteristics of the occupant seating area, which can range from an empty seat, an object on the seat, a human occupant, etc. Herein, image data of the seating area is generally referred to as occupant data, which includes all animate and inanimate objects that might occupy the occupant seating area. The air bag control algorithm associated with the controller 50 can be made sensitive to the provided image data. For example, if the provided image data indicates that the occupant 40 is an object, such as a shopping bag, and not a human being, actuating the air bag during a crash event serves no purpose. Accordingly, the air bag controller 50 can include a pattern recognition classifier assembly 54 operative to distinguish between a plurality of occupant classes based on the image data provided by the camera controller 80 that can then, in turn, be used to control the air bag.

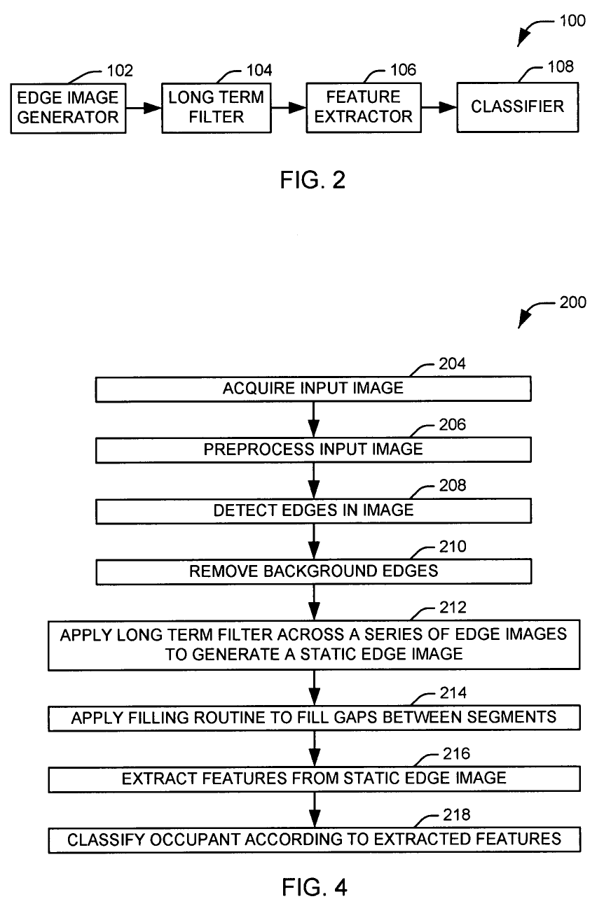

FIG. 2 illustrates a vehicle occupant classification system 100 utilizing long term filtering in accordance with an aspect of the present invention. It will be appreciated that the term “vehicle occupant” is used broadly to include any individual or object that may be positioned on a vehicle seat. Appropriate occupant classes can represent, for example, children, adults, various child and infant seats, common objects, and an empty seat class, as well as subdivisions of these classes (e.g., a class for adults exceeding the ninetieth percentile in height or weight). It will be appreciated that the system can be implemented, at least in part, as a software program operating on a general purpose processor. Therefore, the structures described herein may be considered to refer to individual modules and tasks with a software program. Alternatively, the system 100 can be implemented as dedicated hardware or as some combination of hardware and software.

Edge image representations of the vehicle interior are generated at an edge image generation component 102. The edge image generation component 102 can comprise, for example, a camera operative to image a portion of the vehicle interior associated with a vehicle occupant, having an appropriate modality (e.g., visible light) for edge detection. An edge detection algorithm can then be utilized to produce an edge image from each of a plurality of images of the vehicle interior. The edge images are then provided to a long term filtering component 104. The long term filtering component 104 is applied across a series of edge images to produce a static edge image that contains stationary edges, that is, edges that have persisted over a defined period of time. In one implementation, previous edge images are stored in a rolling buffer, such that each static edge image is created from a current edge image and a known number of previous edge images.

The static edge image is provided to a feature extraction component 106 that determines one or more numerical features representing the static edge image, referred to as feature variables. The selected features can be literally any values derived from the static edge image that vary sufficiently among the various occupant classes to serve as a basis for discriminating between them. Numerical data extracted from the features can be conceived for computational purposes as a feature vector, with each element of the vector representing a value derived from one feature within the pattern. Features can be selected by any reasonable method, but typically, appropriate features will be selected by experimentation.

The extracted feature vector is then provided to classification component 108 comprising one or more pattern recognition classifiers. The classification component 108 relates the feature vector to a most likely occupant class from a plurality of occupant classes, and determines a confidence value that the vehicle occupant is a member of the selected class. This can be accomplished by any appropriate classification technique, including statistical classifiers, neural network classifier, support vector machines, Gaussian mixture models, and K-nearest neighbor algorithms. The selected output class can then provided, through an appropriate interface (not shown), to a controller for an actuatable occupant restraint device, where it is used to regulate operation of an actuatable occupant restraint device associated with the vehicle occupant.

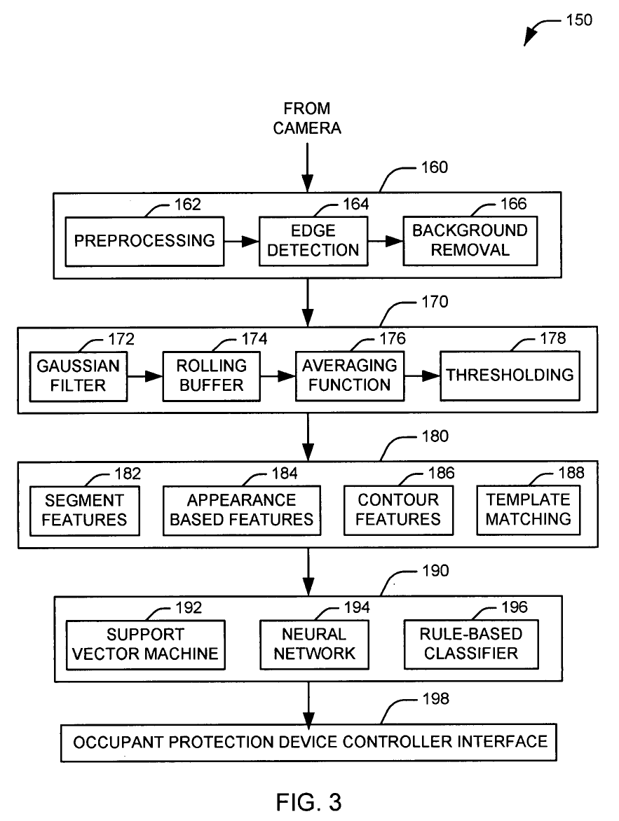

FIG. 3 illustrates an exemplary vehicle occupant classification system 150 utilizing long term filtering in accordance with an aspect of the present invention. It will be appreciated that the term “vehicle occupant” is used broadly to include any individual or object that may be positioned on a vehicle seat. Appropriate occupant classes can represent, for example, children, adults, various child and infant seats, common objects, and an empty seat class, as well as subdivisions of these classes (e.g., a class for adults exceeding the ninetieth percentile in height or weight). It will be appreciated that the system can be implemented, at least in part, as a software program operating on a general purpose processor. Therefore, the structures described herein may be considered to refer to individual modules and tasks with a software program. Alternatively, the system 150 can be implemented as dedicated hardware or as some combination of hardware and software. It will be appreciated that the illustrated system can work in combination with other classification systems as well as utilize classification features that are drawn from sources other than the long term filtered edge image.

An image of the vehicle occupant is provided to an edge image generation component 160 that produces an edge image representing the occupant. A preprocessing element 162 applies one or more preprocessing techniques to the image to enhance features of interest, eliminate obvious noise, and facilitate edge detection. An edge detection element 164 applies an edge detection algorithm (e.g., Canny edge detection) to extract any edges from the image. A direction value associated with each pixel during edge detection can retained as an indication of the direction of the edge gradient. A background removal element 166 removes edges from the image that are not associated with the occupant. Generally, the position and direction of background edges associated with the vehicle interior will be known, such that they can be identified and removed from the image.

A static edge image, representing the portion of the occupant contour that is constant or nearly constant over a period of time, is produced at a long term filtering component 170. A Gaussian filter 172 is applied to the image to obscure small changes in the occupant's position. The Gaussian filtered images are stored in a rolling FIFO (First In, First Out) buffer 174 that stores a defined number of edge images that preceded the current edge image. An averaging element 176 can average associated values (e.g., grayscale values) of corresponding pixels across the images in the rolling buffer to produce a composite image, where the associated value of each pixel is equal to the average (e.g., mean) of pixels in the corresponding position in the images in the roller buffer. The composite image can then be passed to a thresholding element 178 that assigns each pixel having the value satisfying a threshold value a value of one or “dark” and each pixel having a value not satisfying the threshold a value of zero or “light”. The image produced by the thresholding element 178, referred to as a static edge image, represents a static portion of the occupant image. This static edge image can be further enhanced by one or more edge filling algorithms to eliminate gaps between adjacent segments.

A feature extraction component 180 can extract features representing the occupant from the static edge image. For example, a segment feature extractor 182 can determine descriptive statistics from the individual edge segments comprising the static edge image. An appearance based feature extractor 184 can extract features from various regions of the static edge image. For example, the appearance based feature extractor can divide the image into a grid having a plurality of regions, and extract features representing each region in the grid. A contour feature extractor 186 defines a contour around the static edge image and extracts a plurality of features describing the contour. A template matching element 188 compares a plurality of templates to the static edge image. The extracting features can include confidence values representing the degree to which each template matches the image.

The extracted features can then be provided to a classification component 190 that selects an appropriate occupant class for the occupant according to the extracted features. The classification component 190 can comprise one or more pattern recognition classifiers 192, 194, and 196, each of which utilize the extracted features or a subset of the extracted features to determine an appropriate occupant class for the occupant. Where multiple classifiers are used, an arbitration element (not shown) can be utilized to provide a coherent result from the plurality of classifiers. Each classifier (e.g., 192) is trained on a plurality of training images representing the various occupant classes. The training process of the a given classifier will vary with its implementation, but the training generally involves a statistical aggregation of training data from a plurality of training images into one or more parameters associated with the output class. For example, a support vector machine (SVM) classifier can process the training data to produce functions representing boundaries in a feature space defined by the various attributes of interest. Similarly, an artificial neural network (ANN) classifier can process the training data to determine a set of interconnection weights corresponding to the interconnections between nodes in its associated the neural network.

A SVM classifier 192 can utilize a plurality of functions, referred to as hyperplanes, to conceptually divide boundaries in the N-dimensional feature space, where each of the N dimensions represents one associated feature of the feature vector. The boundaries define a range of feature values associated with each class. Accordingly, an output class and an associated confidence value can be determined for a given input feature vector according to its position in feature space relative to the boundaries.

An ANN classifier 194 comprises a plurality of nodes having a plurality of interconnections. The values from the feature vector are provided to a plurality of input nodes. The input nodes each provide these input values to layers of one or more intermediate nodes. A given intermediate node receives one or more output values from previous nodes. The received values are weighted according to a series of weights established during the training of the classifier. An intermediate node translates its received values into a single output according to a transfer function at the node. For example, the intermediate node can sum the received values and subject the sum to a binary step function. A final layer of nodes provides the confidence values for the output classes of the ANN, with each node having an associated value representing a confidence for one of the associated output classes of the classifier.

A rule-based classifier 196 applies a set of logical rules to the extracted features to select an output class. Generally, the rules are applied in order, with the logical result at each step influencing the analysis at later steps. For example, an occupant class can be selected outright when one or more templates associated with the class match the static edge image with a sufficiently high confidence. Once the classification component 190 selects an appropriate output class, the selected class can be provided to a controller interface 198 that provides the selected class to a controller associated with an occupant protection device, such that the operation of the occupant protection device can be regulated according to the classification of the occupant.

Referring to FIG. 4, a classification process 200, in accordance with an exemplary implementation of the present invention, is shown. The illustrated process 200 determines an associated output class for an input image from a plurality of output classes. Although serial processing is shown, the flow chart is given for explanation purposes only and the order of the steps and the type of processing can vary from that shown.

At step 204, a series of input images is acquired. For example, the input image can be acquired by a camera located in a headliner of the vehicle. The acquired image is preprocessed in step 206 to remove background information and noise. For example, certain regions of the image associated with highly reflective objects (e.g., radio, shift knob, instrument panels, etc.) can be eliminated from the image. The image can also be processed to better emphasize desired image features and maximize the contrast between structures in the image. For example, a contrast limited adaptive histogram equalization (CLAHE) process can be applied to adjust the image for lighting conditions based on an adaptive equalization algorithm. The CLAHE process lessens the influence of saturation resulting from direct sunlight and low contrast dark regions caused by insufficient lighting. The CLAHE process subdivides the image into contextual regions and applies a histogram-based equalization to each region. The equalization process distributes the grayscale values in each region across a wider range to accentuate the contrast between structures within the region. This can make otherwise hidden features of the image more visible.

At step 208, edges within the image can be detected via an appropriate edge detection algorithm. For example, a Canny edge detection algorithm can be used to extract the edges from the image. In one implementation, a direction value associated with each pixel during edge detection is retained indicating the direction of the edge gradient. At step 210, known background edges can be removed from the image to produce an edge image representing the occupant.

At step 212, a long term filter is applied across a series of edge images to produce a static edge image that represents relatively stationary edges within the image. For example, each image can be stored in a rolling buffer and blurred with a Gaussian filter to obscure small changes in the edge position. Values (e.g., grayscale values) associated with corresponding pixels can be averaged across the edge images in the rolling buffer. The averaged value for each pixel within the resulting averaged edge image can then be compared to a threshold value with pixels exceeding the threshold having a value of one or “dark” in the static image and pixels failing to exceed the threshold having a value of zero or “white.” The image is then corrected at step 214 via an edge filling routine that fills in gaps between proximate edge segments. For example, a pattern based approach can be utilized wherein a pixel or group of pixels can be filled in (e.g., converted to a value of one) where the pixels surrounding the pixels match one of a plurality of patterns. Similarly, a seed fill approach can be used, where a “seed” pixel is selected, and the edge is extended iteratively to meet with other edge pixels in its immediate neighborhood. Neighborhoods of various sizes and shapes can be used.

At step 216, feature data is extracted from the static edge image in the form of a feature vector. A feature vector represents an image as a plurality of elements representing features of interest within the image. Each element can assume a value corresponding to a quantifiable image feature. It will be appreciated the image features can include any quantifiable features associated with the image that are useful in distinguishing among the plurality of output classes. In general, the features that can be extracted from a given image can be loosely categorized into four general sets. It will be appreciated that features drawn from one or more of these four sets can be used in each of one or more classifiers associated with the system.

One set of features that can be extracted is a set of descriptive statistics representing the edge segments comprising the static edge image. For example, descriptive statistics for each segment can include extreme or average values for the size in pixels of each segment, the height, width, and area of bounding boxes defined around the segments, a filling time of each segment (e.g., the number of iterations needed to fill in the segment during the iterative fill process), bending energy or average curvature, the number of pixels connected to multiple pixels, referred to as forked pixels, within each segment, and the location (e.g., coordinate of centroid). These values can be calculated for all of the segments or for selected subsets of the segments (e.g., subsets falling within defined ranges for one or more of size, bounding box length and width, average curvature, etc.). Similarly, histograms of these characteristics can be constructed in which counts of segments falling within define ranges of one or more of size, bounding box height, width, and area, filling time, bending energy, forked pixel count and location.

A second set of features focuses on the appearance of the image. Specifically, the static edge image can be divided into a grid having a plurality of regions. The grid can be adaptively generated with differently size and shaped regions to cover the grid image appropriately and completely. The grid can be overlaid on the static edge image, and one or more features can be extracted from each region. These features can include the edge pixel intensity (e.g., the normalized number of edge pixels in each region), the average orientation of all edge pixels within the region, average curvature of all pixels within the region, and any other appropriate appearance-based metrics that can be extracted from the defined regions.

A third set of features can be derived from a contour defined around the static edge image. For example, a convex hull algorithm can be used to define a convex envelope around the static edge segments. A centroid of this convex envelope can be located, and a plurality of features can be defined according to the shape, size, and centroid location of the convex envelope. In one implementation, the features are selected as to be invariant to changes in the image scale, translation of the image, and rotation of the image. For example, a signal can be generated comprising the distance of the envelope to the centroid at each of a plurality of discrete angles, and the features can comprise a selected subset of Fourier coefficients that have been determined from a Fourier transform of the signal.

A fourth set of features focuses on primary edge matching. In primary edge matching, the static edge image is searched for certain edge templates or patterns. These templates can be extracted from training images and stored in a template library. Each template can then matched to the static edge image with certain degrees of freedom in changing the position, rotation, and scale. A correlation score can be calculated for each segment for use as feature values. In one implementation, the primary edge matching features can be utilized in a rule based classification system. For example, if a specified number of templates associated with a given occupant class achieve a threshold correlation value, the occupant is classified into the class.

Once the numerical feature values have been extracted to a feature vector, it is provided to one or more pattern recognition classifiers for evaluation at step 218. The one or more pattern recognition classifiers represent a plurality of occupant classes associated with the system. For example, the occupant classes can represent potential occupants of a passenger seat, such as a child class, an adult class, a rearward facing infant seat class, an empty seat class, and similar useful classes.

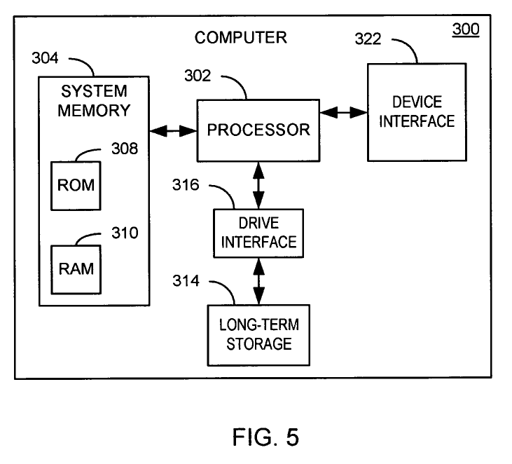

FIG. 5 illustrates a computer system 300 that can be employed as part of a vehicle occupant protection device controller to implement systems and methods described herein, such as based on computer executable instructions running on the computer system. The computer system 300 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. Dual microprocessors and other multi-processor architectures can also be utilized as the processor 302. The processor 302 and system memory 304 can be coupled by any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) can reside in the ROM 308, generally containing the basic routines that help to transfer information between elements within the computer system 300, such as a reset or power-up.

The computer system 300 can include one or more types of long-term data storage 314, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 302 by a drive interface 316, The long-term storage components 314 provide nonvolatile storage of data, data structures, and computer-executable instructions for the computer system 300. A number of program modules may also be stored in one or more of the drives as well as in the RAM 310, including an operating system, one or more application programs, other program modules, and program data.

Other vehicle systems can communicate with the computer system via a device interface 322. For example, one or more devices and sensors can be connected to the system bus 306 by one or more of a parallel port, a serial port or a universal serial bus (USB).

From the above description of the invention, those skilled in the art will perceive improvements, changes, and modifications. Such improvements, changes, and modifications within the skill of the art are intended to be covered by the appended claims.

Having described the invention, the following is claimed:

1. A method for classifying a vehicle occupant into one of a plurality of occupant classes, comprising:
producing a series of edge images of the vehicle occupant;
filtering across the series of edge images to produce a static edge image;
extracting a plurality of features from the static edge image; and
selecting an occupant class for the vehicle occupant according to the extracted plurality of features.

2. The method of claim 1, wherein filtering across a series of edge images of the vehicle occupant comprises:
blurring each of the series of edge images with a Gaussian filter;
averaging associated values of corresponding edge pixels across the series of edge images to produce an averaged edge image, with each pixel in the averaged edge image having an associated value equal to the averaged value of its corresponding edge pixels in the series of edge images; and
comparing the value of each pixel within the averaged edge image to a threshold value with pixels exceeding the threshold having a first value in the static edge image and pixels failing to exceed the threshold having a second value in the static edge image.

3. The method of claim 1, further comprising applying a filling routine to the static edge image to fill in gaps between proximate edge segments.

4. The method of claim 1, wherein extracting a plurality of features from the static edge image comprises calculating at least one set of descriptive statistics representing the individual edge segments comprising the static edge image.

5. The method of claim 1, wherein extracting a plurality of features from the static edge image comprises dividing the static edge image into a plurality of regions and determining at least one metric representing each region.

6. The method of claim 1, wherein extracting a plurality of features from the static edge image comprises defining a contour around the static edge image and extracting at least one feature from the defined contour.

7. The method of claim 6, wherein defining a contour around the static edge image comprises applying a convex hull algorithm to define a convex envelope around the static edge image.

8. The method of claim 1, wherein extracting a plurality of features from the static edge image comprises searching the static edge image for at least one of a plurality of stored templates, a given template being associated with at least one of the plurality of occupant classes.

9. The method of claim 8, wherein searching the static edge image for the at least one template includes searching a portion of the static edge image for a portion of the image that substantially matches a given template within a defined range of at least one of position, rotation, and scale.

10. A classification system for a vehicle occupant protection device, comprising:
an edge image generation component that produces an edge image of a vehicle occupant;
a buffer that stores a plurality of edge images produced by the edge image generation component;
a long term filtering component that filters across the plurality of edge images stored in the buffer to produce a static edge image;
a feature extraction component that extracts a plurality of features from the static edge image; and
a classification component that selects an occupant class for the vehicle occupant according to the extracted plurality of features.

11. The system of claim 10, the feature extraction component comprising a segment feature extractor that calculates at least one set of descriptive statistics representing individual edge segments comprising the static edge image.

12. The system of claim 10, the feature extraction component comprising a template matching element that searches the static edge image for at least one of a plurality of stored templates that are associated with respective occupant classes.

13. The system of claim 10, the classification component comprising an artificial neural network.

14. The system of claim 10, the long term filtering component comprising:
an averaging element that averages associated values of corresponding edge pixels across the plurality of edge images stored in the buffer to produce an averaged edge image; and
a thresholding element that compares the value of each pixel within the averaged edge image to a threshold value with pixels exceeding the threshold having a first value in the static edge image and pixels failing to meet the threshold having a second value in the static edge image.

15. The system of claim 10, further comprising an edge filling routine that fills in gaps between proximate edge segments in the static edge image.

16. A computer readable medium comprising a plurality of executable instructions that can be executed by a data processing system, the executable instructions comprising:
an edge image generation component that produces a series of edge images of a vehicle occupant;
a long term filtering component that filters across the series of edge images to produce a static edge image;
a feature extraction component that extracts a plurality of features from the static edge image;
a classification component that selects an occupant class for the vehicle occupant according to the extracted plurality of features; and
a controller interface that provides the selected occupant class to a vehicle occupant protection device.

17. The computer readable medium of claim 16, the feature extraction component further comprising an appearance based feature extractor that divides the static edge image into a plurality of regions and determines at least one metric representing each region.

18. The computer readable medium of claim 16, the feature extraction component further comprising a contour feature extractor that defines a contour around the static edge image and extracts at least one feature from the defined contour.

19. The computer readable medium of claim 16, the classification component comprising a rule based classifier that applies at least one logical rule to the extracted features to select an occupant class.

20. The computer readable medium of claim 16, the classification component comprising a support vector machine.
